(19) United States
(12) Patent Application Publication
(10) Pub. No.: US 2011/0182447 A1
(43) Pub. Date: Jul. 28, 2011

(54) HUMAN BODY SOUND TRANSMISSION APPARATUS

(75) Inventors: Sung Eun KIM, Seoul (KR); Jung Hwan Hwang, Daejeon (KR); Tae Wook Kang, Daejeon (KR); Sung Weon Kang, Daejeon (KR); Tae Young Kang, Daejeon (KR); Kyung Soo Kim, Daejeon (KR); Jung Bum Kim, Daejeon (KR); Jin Kyung Kim, Daejeon (KR); Kyung Hwan Park, Daejeon (KR); Hyung II Park, Daejeon (KR); In Gi Lim, Daejeon (KR); Byoung Gun Choi, Daegu (KR); Chang Hee Hyoung, Daejeon (KR); Seok Bong Hyun, Daejeon (KR)

(73) Assignee: Electronics and Telecommunications Research Institute, Daejeon (KR)

(21) Appl. No.: 13/010,061

(22) Filed: Jan. 20, 2011

(30) Foreign Application Priority Data
Jan. 22, 2010 (KR) 10-2010-0006154
Jan. 14, 2011 (KR) 1020110003765

(51) Int. Cl. H04R 25/00

(52) U.S. Cl. 381/151

(57) ABSTRACT

A provided a human body sound transmission apparatus includes: a processing unit processing an audio signal of an audio frequency band including data desired to be transmitted, an audio high frequency signal obtained by combining the audio signal and a first high frequency signal, and a second high frequency signal; and a transmission unit receiving a signal obtained by combining the audio high frequency signal and the second high frequency signal from the processing unit and transmitting the received signal by using a human body as a medium, wherein the audio high frequency signal and the second high frequency signal are combined to be transmitted by using the single transmission unit.

### CROSS-REFERENCE TO RELATED APPLICATIONS

This application claims the priority of Korean Patent Application No. 10-2010-0006154 filed on Jan. 22, 2010 and No. 10-2011-0003765 filed on Jan. 14, 2011, in the Korean Intellectual Property Office, the disclosure of which is incorporated herein by reference.

### BACKGROUND OF THE INVENTION

1. Field of the Invention

The present invention relates to a human body sound transmission apparatus and, more particularly, to a human body sound transmission apparatus using a single transmission unit.

2. Description of the Related Art

Human body communication refers to a technique of transferring a signal through a change in electric energy by using a human body, instead of a cable, namely, eliminating a cable from an electronic product, based on the principle in which a human body conducts electricity.

A human body sound transmission technique refers to a technique of transmitting an audio signal (i.e., an audible signal, an acoustic signal, or a sound signal) by using a human body as a transmission medium. Namely, the human body sound transmission technique refers to a technique of using the principle in which an audio signal modulated into a signal of a high frequency band and an high frequency signal for modulating the audio signal are applied to a human body, and in this case, the two applied signals are frequency-mixed due to destructive interference, while being transmitted through the human body, to generate an audio signal.

The related art human body sound transmission apparatus devised for transmitting an audio signal by using a human body as a transmission medium uses two sound transmission units. Namely, in the related art sound transmission apparatus, one sound transmission unit transmits an audio signal desired to be transmitted by the transmission apparatus to a human body and the other sound transmission unit transmits an high frequency signal to the human body, whereby a hearing organ part of the human body listens to a corresponding sound.

However, because the related art human body sound transmission apparatus requires two independent sound transmission units, a problem arises in that the amplitude or quality of a restored sound are affected by contact positions of the respective sound transmission units on a human body (namely, where the sound transmission units are placed to be in contact with the human body), or the like.

### SUMMARY OF THE INVENTION

An aspect of the present invention provides a human body sound transmission apparatus using a single transmission unit.

According to an aspect of the present invention, there is provided a human body sound transmission apparatus including: a processing unit processing an audio signal of an audio frequency band including data desired to be transmitted, an audio high frequency signal obtained by combining the audio signal and a first high frequency signal, and a second high frequency signal; and a transmission unit receiving a signal obtained by combining the audio high frequency signal and the second high frequency signal from the processing unit and transmitting the received signal by using a human body as a medium, wherein the audio high frequency signal and the second high frequency signal are combined to be transmitted by using the single transmission unit.

The human body sound transmission apparatus may further include: a controller providing a control command with respect to a phase and frequency of the audio signal, the audio high frequency signal, the first high frequency signal, and the second high frequency signal to the processing unit, by reflecting a state of the medium.

The human body sound transmission apparatus may further include: a detection unit detecting a state of the medium, wherein a state of the medium may include the distance between the human body sound transmission apparatus and a hearing organ of the human body.

The controller may provide a control command with respect to a phase and frequency of the audio signal, the audio high frequency signal, the first high frequency signal, and the second high frequency signal to the processing unit, by reflecting a state of the medium detected by the detection unit.

The processing unit may include: an audio signal generation module generating the audio signal; an high frequency signal generation module generating the first and second high frequency signals; a signal synthesizing module synthesizing the audio signal and the first high frequency signal to generate the audio high frequency signal; and a signal combining module combining the generated audio high frequency signal and the second high frequency signal.

The processing unit may include: an audio signal generation module generating the audio signal; an high frequency signal generation module generating the first and second high frequency signals; a signal synthesizing module synthesizing the audio signal and the first high frequency signal to generate the audio high frequency signal; and a signal combining module combining the generated audio high frequency signal and the second high frequency signal.

The audio signal generation module may adjust the frequency of the audio signal according to the control command, which reflects the state of the medium, from the controller.

The high frequency signal generation module may adjust the frequency of the first and second high frequency signals according to the control command, which reflects the state of the medium, from the controller.

The signal combining module may adjust the phase of the audio high frequency signal and that of the second high frequency signal according to the control command, which reflects the state of the medium, from the controller.

The signal combining module may adjust the phase of the audio high frequency signal and that of the second high frequency signal according to the control command in consideration of impedance matching with the medium.

The human body sound transmission apparatus may further include: a calibration module performing calibration on the signal obtained by combining the audio high frequency signal and the second high frequency signal; and an amplifying module amplifying the calibrated combination signal of the of the audio high frequency signal and the second high frequency signal and providing the amplified signal to the transmission unit.

The calibration module may perform a calibration on the signal obtained by combining the audio high frequency signal and the second high frequency signal according to a control command, which reflects the state of the medium, from the controller.

The human body sound transmission apparatus may further include: an amplifying module amplifying the signal obtained by combining the audio high frequency signal and the second high frequency signal; and a calibration module performing calibration on the amplified combination signal of the audio high frequency signal and the second high frequency signal, and providing the calibrated signal to the transmission unit.

The calibration module may perform a calibration on the signal obtained by combining the audio high frequency signal and the second high frequency signal according to a control command, which reflects the state of the medium, from the controller.

The frequency of the first high frequency signal and that of the second high frequency signal are the same.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view showing a human body sound transmission apparatus according to an exemplary embodiment of the present invention;

FIG. 2 is a schematic block diagram of the human body sound transmission apparatus according to an exemplary embodiment of the present invention;

FIG. 3 is a schematic block diagram of a processing unit in the human body sound transmission apparatus according to an exemplary embodiment of the present invention;

FIG. 4 is a schematic block diagram of another processing unit in the human body sound transmission apparatus according to an exemplary embodiment of the present invention; and

FIG. 5 is a schematic block diagram of another processing unit in the human body sound transmission apparatus according to an exemplary embodiment of the present invention.

### DETAILED DESCRIPTION OF THE PREFERRED EMBODIMENT

The present invention may be modified variably and may have various embodiments, particular examples of which will be illustrated in drawings and described in detail.

However, it should be understood that the following exemplifying description of the invention is not intended to restrict the invention to specific forms of the present invention but rather the present invention is meant to cover all modifications, similarities and alternatives which are included in the spirit and scope of the present invention.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

When a component is mentioned as being “connected” to or “accessing” another component, this may mean that it is directly connected to or accessing the other component, but it is to be understood that another component may exist therebetween. On the other hand, when a component is mentioned as being “directly connected” to or “directly accessing” another component, it is to be understood that there are no other components in-between.

The terms used in the present application are merely used to describe particular embodiments, and are not intended to limit the present invention. An expression used in the singular encompasses the expression of the plural, unless it has a clearly different meaning in the context in which it is used. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Embodiments of the present invention will be described below in detail with reference to the accompanying drawings, where those components are rendered using the same reference number that are the same or are in correspondence, regardless of the figure number, and redundant explanations are omitted.

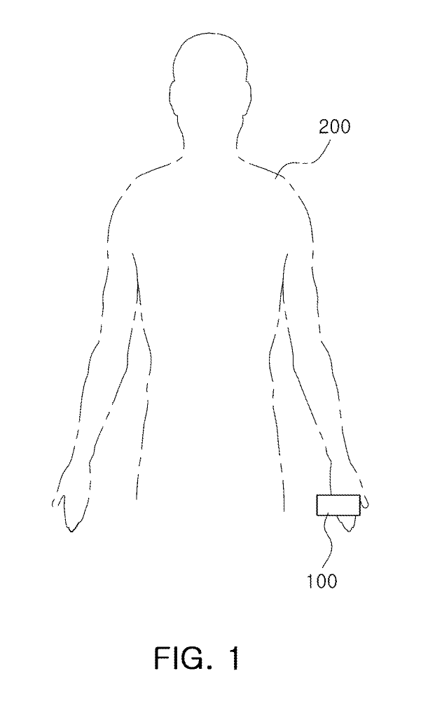

FIG. 1 is a view showing a human body sound transmission apparatus according to an exemplary embodiment of the present invention.

As shown in FIG. 1, a human body sound transmission apparatus 100 is configured to be directly in contact with a human body 200. Namely, without performing a data processing procedure for demodulating a signal transmitted by using the human body 200 as a communication channel, only a sound signal can be directly received through a destructive interference between signals transmitted from a transmission device or nonlinearlity of the human body.

In this case, the human body sound transmission apparatus 100 outputs all signals through a single transmission unit, whereby influence regarding a restoration of an audio signal according to positions and performance of respective elements generated in an existing method using two or more transmission elements can be minimized and restoration efficiency of an audio signal can be improved.

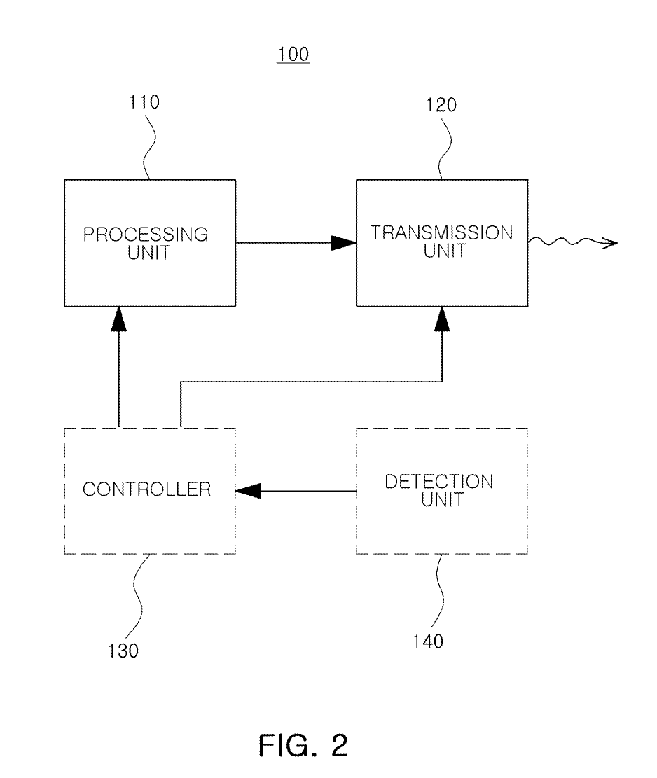

FIG. 2 is a schematic block diagram of the human body sound transmission apparatus according to an exemplary embodiment of the present invention.

With reference to FIG. 2, a human body sound transmission apparatus 100 according to an exemplary embodiment of the present invention includes a processing unit 110 processing an audio signal of an audio frequency band including data desired to be transmitted, an audio high frequency signal obtained by combining the audio signal and a first high frequency signal, and a second high frequency signal, and a transmission unit 120 receiving a signal obtained by combining the audio high frequency signal and the second high frequency signal from the processing unit and transmitting the received signal by using a human body as a medium.

In particular, the audio high frequency signal and the second high frequency signal are combined and transmitted together by using the single transmission unit.

In addition, the human body sound transmission apparatus 100 according to an exemplary embodiment of the present invention may be a hand-held type apparatus.

The human body sound transmission apparatus 100 according to an exemplary embodiment of the present invention may further include a controller 130 providing a control command with respect to a phase and frequency of the audio signal, the audio high frequency signal, the first high frequency signal, and the second high frequency signal to the processing unit, by reflecting a state of the medium.

Also, the human body sound transmission apparatus 100 according to an exemplary embodiment of the present invention may further include a detection unit 140 detecting a state of the medium, and here, a state of the medium may include the distance between the human body sound transmission apparatus and a hearing organ of the human body.

Namely, the state of the medium may include the distance between the human body sound transmission apparatus 100 and the hearing organ of the human body, and may also include impedance according to the distance between the human body sound transmission apparatus 100 and the hearing organ of the human body.

In this case, the controller may provide a control command with respect to a phase and frequency of the audio signal, the audio high frequency signal, the first high frequency signal, and the second high frequency signal to the processing unit, by reflecting a state of the medium detected by the detection unit.

Namely, the controller may provide a control command such as changing, or the like, with respect to a phase and frequency of the audio signal, the audio high frequency signal, the first high frequency signal, and the second high frequency signal in consideration of the distance between the human body sound transmission apparatus 100 and the hearing organ of the human body and impedance according to the distance detected by the detection unit 140.

Meanwhile, the transmission unit 120 receives the signal obtained by combining the audio high frequency signal and the second high frequency signal from the processing unit 110 and transmits the signal by using the human body as a medium, and in this case, the transmission unit 120 may be directly in contact with the human body 200 and output the combination signal of the audio high frequency signal and the second high frequency signal to the human body.

In this case, the transmission unit 120 serves to acoustically couple the human body sound transmission apparatus 100 and the human body 200. Namely, the transmission unit 120 is a sort of transducer which is able to transmit a desired signal in the form of a vibration signal to the human body.

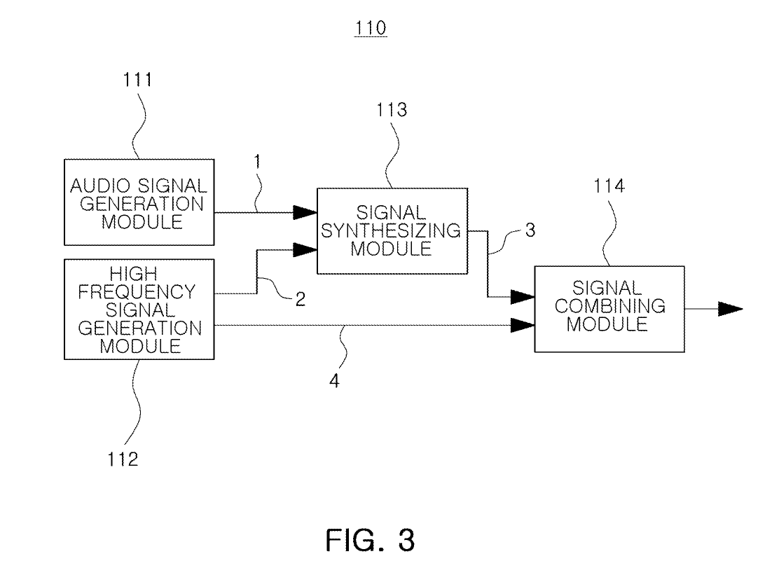

FIG. 3 is a schematic block diagram of a processing unit in the human body sound transmission apparatus according to an exemplary embodiment of the present invention.

With reference to FIGS. 2 and 3, the processing unit may include an audio signal generation module 111 generating the audio signal 1, an high frequency signal generation module 112 generating the first high frequency signal 2 and the second high frequency signal 3, a signal synthesizing module 113 synthesizing the audio signal 1 and the first high frequency signal 2 to generate the audio high frequency signal 3, and a signal combining module 114 combining the generated audio high frequency signal 3 and the second high frequency signal 4.

Namely, the processing unit 110 includes the audio signal generation module 111, the high frequency signal generation module 112, the signal synthesizing module 113, and the signal combining module 114 in order to process the audio signal of an audio frequency band including the data desired to be transmitted, the audio high frequency signal obtained by combining the audio signal and the first high frequency signal, and the second high frequency signal.

The audio signal generation module 111 generates the audio signal, and in this case, the audio signal generation module 111 may adjust the frequency of the audio signal according to the control command, which reflects the state of the medium, from the controller.

Namely, the audio signal generation module 111 may generate the audio signal by increasing or decreasing the frequency of the frequency according to a control command in consideration of the detection results from the detection unit 140 or the state of the medium previously recognized by the detection unit 140.

The high frequency signal generation module 112 generates the first and second high frequency signals. In this case, the high frequency signal generation module 112 may adjust the frequency of the first high frequency signal and that of the second high frequency signal according to a control command, which reflects the state of the medium, from the controller 130.

Namely, like the audio signal generation module 111, the high frequency signal generation module 112 may generate the audio signal by increasing or decreasing the frequency of the first high frequency signal an that of the second high frequency signal according to a control command in consideration of the detection results from the detection unit 140 or the state of the medium previously recognized by the detection unit 140.

The signal synthesizing module 113 may generate the audio high frequency signal by synthesizing the audio signal and the first high frequency signal. Namely, the signal synthesizing module 113 may generate the audio high frequency signal, which is transmitted through one of two transmission units according to the related art method.

In addition, the signal synthesizing module 113 may generate the audio high frequency signal by synthesizing the audio signal and the first high frequency signal according to a control command from the controller 130.

The signal combining module 114 combines the generated audio high frequency signal and the second high frequency signal. The signal combining module 114 may generate the combined signal in order to transmit the audio high frequency signal and the second high frequency signal by using the single transmission unit.

Meanwhile, the signal combining module 114 may adjust the phase of the audio high frequency signal and that of the second high frequency signal according to a control command, which reflects the state of the medium, from the controller 130.

Namely, the signal combining module 114 may change the phase of the audio high frequency signal and that of the second high frequency signal such that it is faster or slower, according to a control command, which considers the detection results from the detection unit 140 or the state of the medium previously recognized by the detection unit 140.

In adjusting the phase of the audio high frequency signal and that of the second high frequency signal by the signal combining module 114, impedance matching with the medium may be considered.

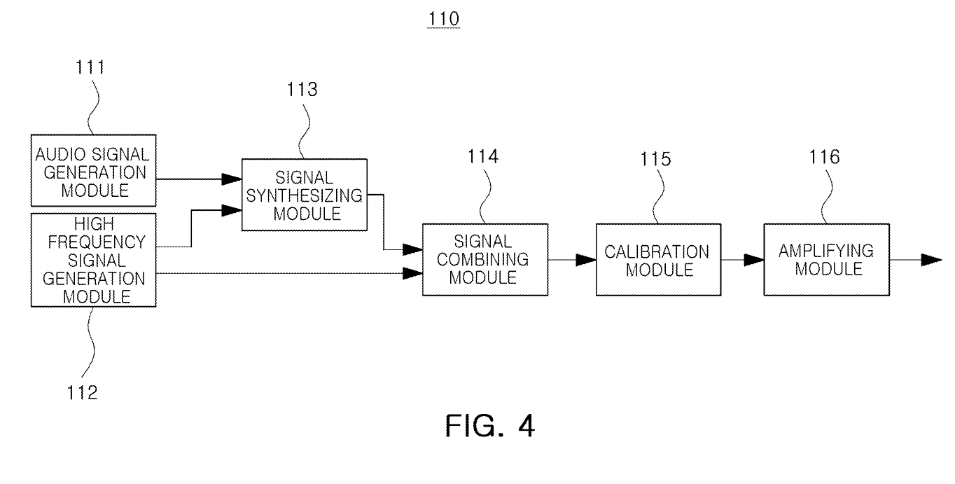

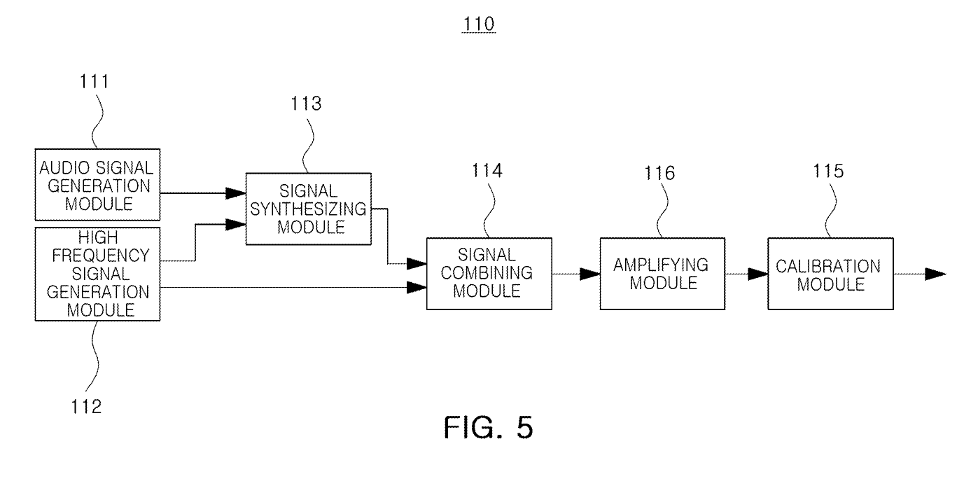

FIG. 4 is a schematic block diagram of another processing unit in the human body sound transmission apparatus according to an exemplary embodiment of the present invention. FIG. 5 is a schematic block diagram of still another processing unit in the human body sound transmission apparatus according to an exemplary embodiment of the present invention.

With reference to FIGS. 2, 3, 4, and 5, the processing unit 110 of the human body sound transmission apparatus 100, according to an exemplary embodiment of the present invention may further include a calibration module 115 performing calibration on the signal obtained by combining the audio high frequency signal and the second high frequency signal, and an amplifying module 116 amplifying the calibrated combination signal of the of the audio high frequency signal and the second high frequency signal and providing the amplified signal to the transmission unit 120, in addition to the audio signal generation module 111, the high frequency signal generation module 112, the signal synthesizing module 113, and the signal combining module 114.

The processing unit 110 may further include an amplifying module 116 amplifying the signal obtained by combining the audio high frequency signal and the second high frequency signal, and a calibration module 115 performing calibration on the amplified combination signal of the audio high frequency signal and the second high frequency signal, and providing the calibrated signal to the transmission unit.

Namely, the calibration module 115 and the amplifying module 116 may be configured in the reverse order, and in the respective cases, the calibration module 115 and the amplifying module 116 may provide a signal, which has undergone a calibration and amplification process, to the transmission unit 120.

Here, the calibration module 115 may perform a calibration on the combination signal of the audio high frequency signal and the second high frequency signal according to a control command, which reflects the state of the medium, from the controller 130.

Namely, the calibration module 115 may perform a calibration on the combination signal of the audio high frequency signal and the second high frequency signal according to a control command in consideration of the detection results from the detection unit 140 or the state of the medium previously recognized by the detection unit 140.

In particular, the human body, namely, the state of the medium, may frequently change, so the controller 130 may issue a control command by reflecting periodical or real time detection results from the detection unit 140, and the calibration module 115 may perform calibration on the combination signal of the audio high frequency signal and the second high frequency signal periodically or in real time.

Meanwhile, in the human body sound transmission apparatus 100 according to an exemplary embodiment of the present invention, the frequency of the first high frequency signal and that of the second high frequency signal may be the same.

Namely, the frequency of the first high frequency signal and that of the second high frequency signal may be different, but they may be set to be the same in order to effectively perform decoding according to destructive interference between signals reaching a hearing organ of the human body or the nonlinearity of the human body, and in this case, a single high frequency signal generator may be used.

As set forth above, according to exemplary embodiments of the invention, only the person (i.e., user) in communication can receive a transmitted sound, obtaining a stereophonic effect without causing noise therearound. Also, because a reception unit is not required, autonomy of behavior can be improved. In particular, because a signal is transmitted by using a single transmission unit, influence of a sound generated with the problems of positions and performance of respective elements in the case of using two transmission units can be minimized and transmission efficiency and restoration efficiency can be enhanced. In addition, the convenience in implementation and use can be maximized.

While the present invention has been shown and described in connection with the exemplary embodiments, it will be apparent to those skilled in the art that modifications and variations can be made without departing from the spirit and scope of the invention as defined by the appended claims.

What is claimed is:

1. A human body sound transmission apparatus comprising:
a processing unit processing an audio signal of an audio frequency band including data desired to be transmitted, an audio high frequency signal obtained by combining the audio signal and a first high frequency signal, and a second high frequency signal; and
a transmission unit receiving a signal obtained by combining the audio high frequency signal and the second high frequency signal from the processing unit and transmitting the received signal by using a human body as a medium,
wherein the audio high frequency signal and the second high frequency signal are combined to be transmitted by using the single transmission unit.

2. The apparatus of claim 1, further comprising:
a controller providing a control command with respect to a phase and frequency of the audio signal, the audio high frequency signal, the first high frequency signal, and the second high frequency signal to the processing unit, by reflecting a state of the medium.

3. The apparatus of claim 2, further comprising:
a detection unit detecting a state of the medium,
wherein a state of the medium comprises the distance between the human body sound transmission apparatus and a hearing organ of the human body.

4. The apparatus of claim 3, wherein the controller provides a control command with respect to a phase and frequency of the audio signal, the audio high frequency signal, the first high frequency signal, and the second high frequency signal to the processing unit, by reflecting a state of the medium detected by the detection unit.

5. The apparatus of claim 1, wherein the processing unit comprises:
an audio signal generation module generating the audio signal;
an high frequency signal generation module generating the first and second high frequency signals;
a signal synthesizing module synthesizing the audio signal and the first high frequency signal to generate the audio high frequency signal; and
a signal combining module combining the generated audio high frequency signal and the second high frequency signal.

6. The apparatus of claim 2, wherein the processing unit comprises:
an audio signal generation module generating the audio signal;
an high frequency signal generation module generating the first and second high frequency signals;
a signal synthesizing module synthesizing the audio signal and the first high frequency signal to generate the audio high frequency signal; and
a signal combining module combining the generated audio high frequency signal and the second high frequency signal.

7. The apparatus of claim 6, wherein the audio signal generation module adjusts the frequency of the audio signal according to the control command, which reflects the state of the medium, from the controller.

8. The apparatus of claim 6, wherein the high frequency signal generation module adjusts the frequency of the first and second high frequency signals according to the control command, which reflects the state of the medium, from the controller.

9. The apparatus of claim 6, wherein the signal combining module adjusts the phase of the audio high frequency signal and that of the second high frequency signal according to the control command, which reflects the state of the medium, from the controller.

10. The apparatus of claim 9, wherein the signal combining module adjusts the phase of the audio high frequency signal and that of the second high frequency signal according to the control command in consideration of impedance matching with the medium.

11. The apparatus of claim 6, further comprising:
a calibration module performing calibration on the signal obtained by combining the audio high frequency signal and the second high frequency signal; and
an amplifying module amplifying the calibrated combination signal of the of the audio high frequency signal and the second high frequency signal and providing the amplified signal to the transmission unit.

12. The apparatus of claim 11, wherein the calibration module performs a calibration on the signal obtained by combining the audio high frequency signal and the second high frequency signal according to a control command, which reflects the state of the medium, from the controller.

13. The apparatus of claim 6, further comprising:
an amplifying module amplifying the signal obtained by combining the audio high frequency signal and the second high frequency signal; and
a calibration module performing calibration on the amplified combination signal of the audio high frequency signal and the second high frequency signal, and providing the calibrated signal to the transmission unit.

14. The apparatus of claim 13, wherein the calibration module performs a calibration on the signal obtained by combining the audio high frequency signal and the second high frequency signal according to a control command, which reflects the state of the medium, from the controller.

15. The apparatus of claim 1, wherein the frequency of the first high frequency signal and that of the second high frequency signal are the same.
